(19) United States
(12) Patent Application Publication
(10) Pub. No.: US 2007/0005289 A1
(43) Pub. Date: Jan. 4, 2007

(54) Temperature compensation apparatus for electronic signal

(75) Inventor: Joe Huang, Taipei (TW)

Correspondence Address: HDSL, 4331 STEVENS BATTLE LANE, FAIRFAX, VA, 22033, US

(73) Assignee: Fortune Semiconductor Corporation

(21) Appl. No.: 11/159,169

(22) Filed: Jun. 23, 2005

(51) Int. Cl. G06F 15/00

(52) U.S. Cl. 702/130

(57) ABSTRACT

A temperature compensation apparatus for an electronic signal, by conversion between digital and analog signals, the internal temperature is corrected and compensated, and the signal output is corrected. The apparatus has a signal converter and a temperature correction unit coupled to the signal conversion unit for performing temperature correction and compensation. The temperature correction unit has a first adder, a first multiplier and a second adder to form a digital circuit. With the real-time measured ambient temperature, reference temperature, temperature compensation coefficient and an input signal, digital arithmetic of temperature correction and compensation is performed, so as to generated the corrected signal output which has been temperature compensated. Thereby, the imprecision caused by temperature drift of reference voltage and inaccuracy is prevented.

### BACKGROUND OF THE INVENTION

1. Field of Invention

The present invention relates in general to a temperature compensation apparatus for an electronic signal, and more particularly, to a temperature correction and compensation apparatus suitable for use in electronic signal correction of infrared, chip, temperature sensor and control, voltage source and current source, which uses a digital circuit to perform calculation, so as to suppress the temperature drift of reference voltage source.

Related Art

The advanced development of electronic technology does not only requires high precision of electronic signal generated or transmitted by the product, but is also very sensitive to the error message caused by environment factor such as temperature variation. Therefore, the modern electronic device or product normally includes a temperature compensation apparatus to manually or automatically compensate the signal affected by external temperature variation.

Currently, various temperature correction and compensation circuits or apparatus for input or output electronic signal input of infrared, chip or temperature control have been disclosed in U.S. Pat. Nos. 5,246,292, 4,488,824, 5,719,378, 6,283,628, 5,455,510, 5,621,306, 6,283,628, 6,332,710, 6,504,697, 6,808,307, 6,736,540, 6,679,628, 6,525,550 and 6,029,251. Most of the temperature correction and compensation circuit or apparatus disclosed above uses a resistor or an operation amplifier, differential operation amplifier to form an analog circuit in combination with an external reference voltage to perform temperature correction and compensation. This analog type of temperature compensation technique is less costly, but cannot resolve the temperature drift problem of the reference voltage source. Therefore, the correction precision is seriously affected by this type of correction and compensation. To overcome the temperature drift problem, the temperature coefficient of the reference voltage source can be configured to approximately zero by certain circuit design or adjustment of semiconductor process parameters. However, such method requires complex circuit design and is very costly. Further, the external temperature drift of the reference voltage source cannot be completely eliminated. Further, the circuit of the converter for each circuit design or application has to be specially designed. This increases the development cost greatly. Alternatively, a standard semiconductor fabrication process is used to fabricate standard reference voltage circuit that has a nearly constant temperature coefficient within a specific range. Adders and multipliers are used to construct a temperature correction circuit to execute digital operation. The temperature dependence of the temperature coefficient of the reference voltage source is thus eliminated by operation of hardware circuit. Consequently, the temperature drift of the reference voltage source can also be suppressed. Further, the converter required for different circuit designs or applications does not have to be different. Therefore, this method does not only have broader application, but also reduces development cost.

### SUMMARY OF THE INVENTION

A plurality of adders and multipliers is used to construct a digital operation circuit operative to execute operation for canceling temperature effect upon the temperature coefficient of the reference voltage source.

In one embodiment, a temperature compensation apparatus for an electronic signal includes a signal converter and a temperature correction unit coupled to the signal converter for correcting and compensating temperature. Temperature compensation operation is performed on an input signal, and an output signal is output by the temperature correction unit. The digital correction unit includes at least a first adder, a first multiplier and a second adder to construct a digital circuit. The first adder is used to perform digital addition on a real-time measured ambient temperature and a reference temperature. A temperature compensation digital signal is output to perform digital multiplication on a temperature compensation coefficient and an input signal. A reference voltage signal is generated and output as one of the input signal of the second adder and summed up with the other input signal thereof Thereby, a corrected and compensated signal result is output.

### BRIEF DESCRIPTION OF THE DRAWINGS

The present invention will become more fully understood from the detailed description given hereinbelow illustration only, and thus are not limitative of the present invention, and wherein:

FIG. 1 shows a block diagram of a temperature compensation apparatus;

FIG. 2 shows a circuit structure of the temperature compensation apparatus;

FIG. 3 schematically shows the bit signal of the temperature compensation digital signal generated by the first adder of the temperature correction unit;

FIG. 4 shows a block diagram of a temperature compensation apparatus provided in another embodiment;

FIG. 5 illustrates a circuit structure of the temperature compensation apparatus as shown in FIG. 4;

FIG. 6 shows a block diagram of a temperature compensation apparatus provided in another embodiment; and

FIG. 7 illustrates a circuit structure of the temperature compensation apparatus as shown in FIG. 6.

### DETAILED DESCRIPTION OF THE INVENTION

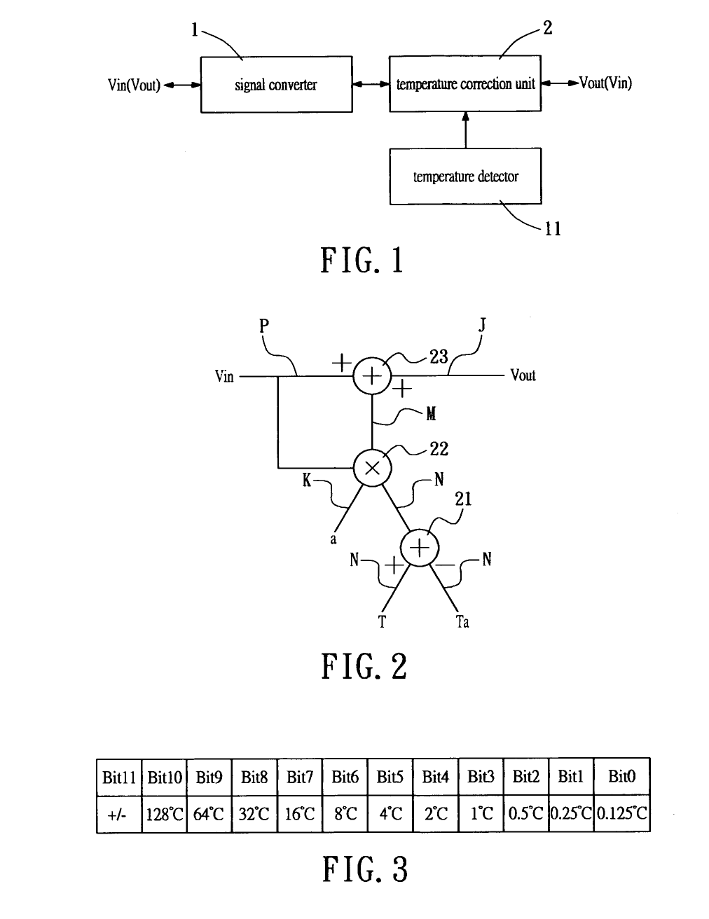

Referring to FIGS. 1 and 2, the temperature compensation apparatus for an electronic signal as provided includes a signal converter 1 and a temperature correction unit 2 coupled to one terminal of the signal converter 1. The signal converter 1 includes one input terminal coupled to an input signal Vin, the other input terminal coupled to the input terminal of the temperature correction unit 2, and an output terminal to output an output signal Vout. Thereby, a digital circuit is constructed to perform temperature correction and compensation during digital-analog conversion of the input signal. Thereby, the output result of the signal converter is corrected more precisely without the requirement of considering the temperature drift of the reference voltage source.

In one embodiment, the signal converter includes an analog-to-digital converter or a digital-to-analog converter coupled to a temperature detector 11 for measuring a real-time ambient temperature. The ambient temperature is represented by a signal value T of the temperature correction unit 2. Preferably, the signal value T is represented by a 21-bit digital, that is, the bus length of T is 12.

The above mentioned temperature correction unit 2, as shown in FIG. 2, includes at least a first adder 21, a first multiplier 22 and a second adder 23 which construct a digital circuit operating the following formula:

$$α = \frac{{V}_{in}}{{V}_{ref}} = \frac{{V}_{in}}{{V}_{ref} ( 1 + a Δ T )} \times ( 1 + a Δ T )$$

where ΔT=T−T_{ref}, Vᵢₙ is the input signal voltage, V_{ref} is the ideal reference source voltage; α is the temperature compensation coefficient, T is the real-time ambient temperature, and T_{ref} is the reference temperature.

By inputting the input signal Vᵢₙ to the above formula, the temperature variation factor is corrected and compensated as a

$$α = \frac{{V}_{in}}{{V}_{ref}} ,$$

which can be used to perform the temperature correction and compensation to obtain the signal output Vₒᵤₜ. Thereby, without considering the temperature drift of the reference voltage source, that is, as the drift factor of temperature coefficient is corrected into a drift factor independent of temperature, the output of the data converter can be precisely corrected.

The first adder extracts the real-time ambient temperature T measured by the temperature detector 11 and a reference temperature signal T_{ref}, which is a reference temperature under normal temperature and have the same bit length of the signal value T. The first adder 21 uses 2's complement to perform operation on the signal value T and a reference T_{ref}, so as to generate and output an N-bit temperature compensation digital signal as shown in FIG. 3. the N-bit temperature compensation digital signal is one of the input digital signal of the first multiplier 22.

The first multiplier 22 extracts the temperature compensation digital signal (N-bit) output by the first adder 21, a temperature compensation coefficient a, and the input signal Vᵢₙ to perform multiplication, so as to generate an M-bit correction voltage signal V_{C} output as an input signal for the second adder 23.

The temperature coefficient α is generated from the reference source voltage of the external circuit according to temperature variation. Preferably, the temperature coefficient α s is obtained by system measurement. The temperature coefficient α is fed back to an α register. The temperature coefficient α is represented in a digital format. In one embodiment, the bus length of the temperature compensation coefficient α is 7, which indicates the compensation capability up to 1024 ppm/° C.

The second adder 23 extracts the input signal Vᵢₙ and the correction voltage V_{C} output from the first multiplier 22 as the signal source and perform digital accumulation to generate an output signal Vₒᵤₜ with J-bit length. Thereby, the drift factor of temperature coefficient is compensated and corrected to achieve the high-precision temperature compensation and correction during analog-digital conversion.

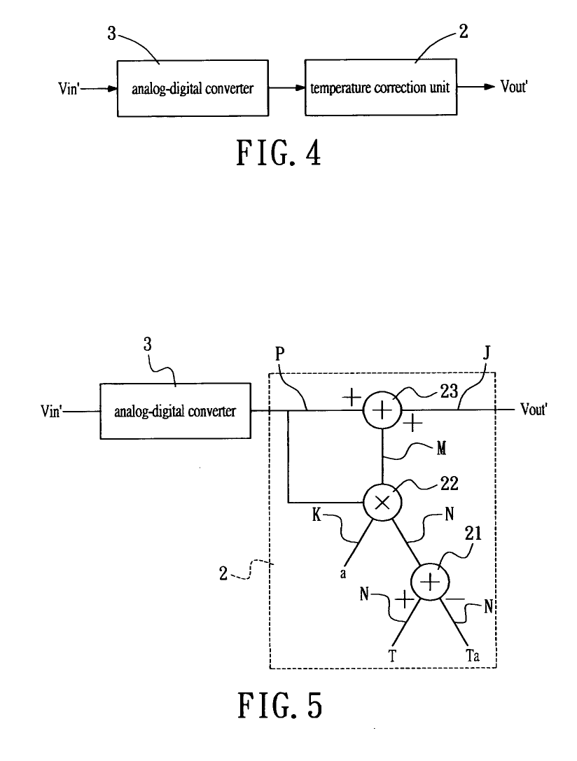

Referring to FIGS. 4 and 5, the block diagram and circuit diagram of a temperature compensation apparatus for electronic signals applied to analog-digital signal conversion are illustrated. As shown, the circuit structures of the analog-digital converter 3 and the temperature correction unit 2 coupled to the analog-digital converter 3 substantially the same as those as shown in FIG. 2.

In this embodiment, one terminal of the analog-digital converter 3 serves as an input source to input an analog signal Vᵢₙ′. Being converted into a digital signal by the analog-digital converter 3, the digital signal is input to the above temperature correction unit 2. The first adder 21, the first multiplier 22 and the second adder 23 are used to construct a digital circuit to perform operation, correction and compensation, so as to generate and output the signal Vₒᵤₜ′.

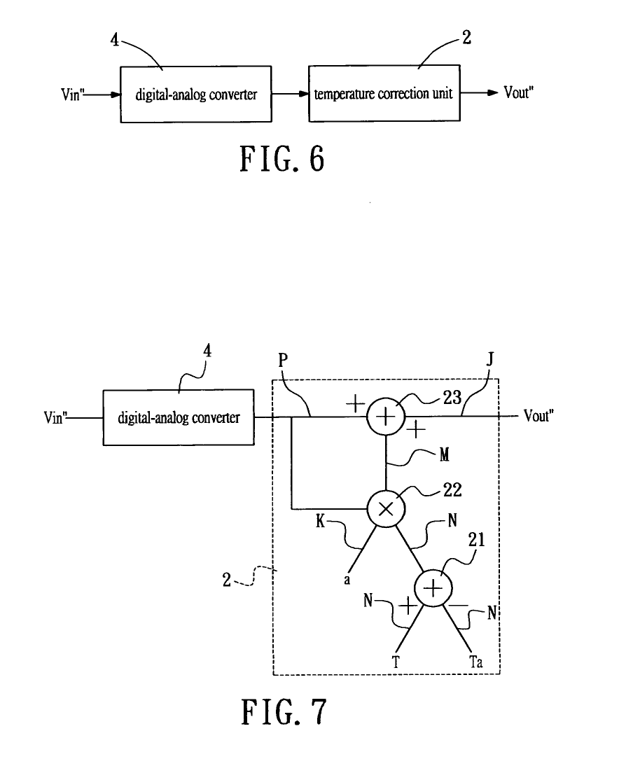

Referring to FIGS. 6 and 7, the temperature compensation of electronic signals is applied to digital-to-analog signal conversion. As shown, a digital-to-analog converter 4 is coupled to a temperature correction unit 2. The temperature correction unit 2 has substantially the same circuit structure as shown in FIG. 2.

In this embodiment, the digital-to-analog converter 4 has one terminal serving as an input source to input the digital signal Vᵢₙ″ to the temperature correction unit 2. The digital signal Vᵢₙ″ is proportional to an external electric signal and can be a voltage signal or a current signal. A first adder 21, a first multiplier 22 and a second adder 23 are used to construct a digital circuit to perform operation, correction and compensation, so as to generate an output signal input to the digital-to-analog converter 4 and converted into the analog output signal Vₒᵤₜ.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A temperature compensation apparatus comprising a temperature correction unit coupled to a signal converter and a temperature sensor to perform temperature compensation and correction, the temperature correction unit comprising:
a first adder extracting an N-bit real-time ambient temperature measured by the temperature sensor and a N-bit reference temperature signal to perform add operation thereon, and to generate an N-bit temperature compensation digital signal;
a first multiplier extracting the temperature compensation digital signal output from the first adder, a P-bit input signal, and a K-bit temperature compensation coefficient and performing multiplication thereon, so as to generate an M-bit correction voltage signal; and
extracting the P-bit digital input signal and the correction voltage signal output from the first multiplier and perform accumulation thereon, so as to generate a output signal that has been temperature compensated and corrected.

2. The apparatus of claim 1, wherein the signal converter includes an analog-to-digital converter.

3. The apparatus of claim 1, wherein the signal converter includes a digital-to-analog converter.

4. The apparatus of claim 1, wherein the real-time ambient temperature is measured in the form of a digital signal and serves as a signal value for the operation performed by the temperature correction unit.

5. The apparatus of claim 4, wherein the reference temperature signal T_{ref} is a reference temperature under normal temperature and is in the form of a digital signal having the same bus length as the signal value.

6. The apparatus of claim 1, wherein N is an integer larger than 0.

7. The apparatus of claim 1, wherein K is an integer larger than 0.

8. The apparatus of claim 1, wherein P is an integer larger than 0.

9. The apparatus of claim 1, wherein M is equal to, smaller than or larger than N+K+P.

10. The apparatus of claim 1, wherein the temperature compensation coefficient is generated according to temperature variation of a reference source voltage supplied by an external circuit and is obtained by system measurement, and the temperature compensation coefficient is fed back to an α register in a digital form, the length of the α register is L, which is an integer larger than 0.

11. A temperature compensation apparatus of an electronic signal, comprising:
an analog-to-digital signal converter having one terminal coupled to an analog input signal; and
a temperature correction unit coupled to the analog-to-digital converter, the temperature correction unit having one terminal for outputting a digital signal.

12. A temperature compensation apparatus for an electronic signal, comprising:
a digital-to-analog signal converter having one terminal coupled to a digital input signal; and
a temperature correction unit coupled to the digital-to-analog converter, the temperature correction unit having one terminal for outputting an analog signal.
